(19) United States
(12) Patent Application Publication
(10) Pub. No.: US 2015/0040685 A1
(43) Pub. Date: Feb. 12, 2015

(54) IMPACT SENSING, EVALUATION & TRACKING SYSTEM

(71) Applicant: HeadCase LLC, Lake Forest, IL (US)

(72) Inventors: Daniel William Nicholson, Lake Forest, IL (US); Thomas Scott Hodgkins, Lake Forest, IL (US)

(73) Assignee: HEADCASE LLC, Lake Forest, IL (US)

(21) Appl. No.: 14/454,744

(22) Filed: Aug. 8, 2014

Related U.S. Application Data
(60) Provisional application No. 61/863,672, filed on Aug. 8, 2013.

(51) Int. Cl. G01L 5/00; A42B 3/30

(52) U.S. Cl. CPC G01L 5/0052; A42B 3/30
USPC 73/862.51

(57) ABSTRACT

An impact sensing and tracking system helps detect concussion risks using a computerized evaluation combined with traditional methods. The system includes impact sensors, a application and a centralized database with a webpage browser interface. Impact sensors are worn on athletes' heads, helmet or other headwear and measure impacts that athletes receive while playing sports. The mobile application includes a real-time test and alert system which assists play-side help detect concussion symptoms, provides medical care notices and reports test results to the database for tracking and analysis. The impact data for each athlete is stored in the database along with tests that have been administered through the application. The system reviews, analyzes and compares impact data to standardized concussion data and stores it as a comprehensive, long-term diagnostic study on diagnosed concussions in athletes that the system uses to evaluate impact severities and concussion risks in specific situations.

### CROSS-REFERENCE TO RELATED APPLICATIONS

This application claims priority from U.S. Provisional Patent Application No. 61/863,672 filed Aug. 8, 2013 which is hereby incorporated by reference.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention relates to concussion risk assessment systems, and more particularly to concussion risk assessment systems in which independent evaluations can be performed with one evaluation using a smart-phone application that guides a user through a play-side concussion risk test for an injured athlete and another evaluation using impact data that is uploaded to a centralized server and evaluated using a statistical analysis.

2. Related Art

Historically, play-side examinations of injured athletes have been used to look for indications that an athlete may be suffering from a concussion, particularly examinations conducted after an athlete has received a hard hit or a fall and displayed some confusion or may even have lost consciousness. However, the vast majority of diagnosed concussions do not involve a loss of consciousness and may not be immediately apparent or may otherwise not have been recognized by play-side help.

In an effort to improve player safety and identify head injuries as early as possible, more recent concussion risk assessment systems produce an alert in real-time when a helmet sensor detects an acceleration that exceeds a threshold value. However, it has been found that many impacts which exceed a particular threshold may not result in an athlete suffering from a concussion. Instead, there are a number of factors in an impact that may increase the likelihood of a concussion or may result in a more severe injury. For example, recent studies have suggested that many concussions may result from a combination of linear and rotational accelerations so systems that do not account for such effects when measuring impacts could result in a false negative report. Additionally, once an athlete has had a first concussion, there is a significant increase in the likelihood that a future impact will result in another concussion, with some research indicating that after a first concussion, the likelihood that another impact will result in a second concussion may increase by a factor of five (5). The problem of increased susceptibility to a second concussion incident is compounded because cumulative concussions have been shown to dramatically increase the likelihood of catastrophic head injury leading to permanent neurologic disability.

Accordingly, these new real-time concussion evaluation systems may have a negative effect of providing a false sense of security. There is the risk that play-side help may believe that these systems will detect head injuries better than traditional methods and may become less attentive to the injuries that they witness for themselves. There will always remain differences in individual responses to the same impact where one athlete can suffer a concussion injury while another athlete may not. Since an athlete who has had one concussion is more likely to suffer a second concussion by a later impact and multiple concussions can increase neurologic damage, a system that is inordinately relied upon but which produces false negatives could be more dangerous to athletes than traditional methods. Additionally, a system that produces false positive warnings during a game could lead to an unnecessary increase in anxiety and the premature removal of athletes from a game while reliance on a system that regularly provides false negative reports will result in more concussions going undiagnosed. Therefore, the importance of attentive play-side help and corresponding experience in having witnessed athletes suffering from concussions and recognizing the many forms of symptoms that may occur should be recognized as another equally valid real-time concussion evaluation system which includes the natural pattern recognition and learning feedback of the play-side helpers.

What is needed is a system that recognizes the continued value in traditional methods of detecting the warning signs of concussions and other head injuries and which also combines the benefits of a computerized concussion risk assessment system. Such a system can improve the attentiveness of play-side help to injuries that they witness by providing them with a standardized tool that prompts the user to perform traditional play-side testing and that evaluates the test results according to a baseline standard. At the same time, since there is no impact data to bias the subjective view of the play-side help, the independence of the traditional methodology is maintained. An identification of risk by the traditional method could trigger a risk evaluation of impact data in the computerized system. Additionally, the computerized system can perform an independent evaluation of the impact data whenever a threshold impact level is exceeded. It would also be beneficial to have a computerized evaluation system that works together with the traditional evaluations and later diagnoses by medical professional to provide feedback to both the computerized system and the play-side helpers so that both forms of concussion evaluations are improved over time.

### SUMMARY OF THE INVENTION

The inventive system is used for monitoring and evaluating impacts to the head of an athlete while wearing a helmet during sporting events and includes an impact sensor, a mobile application and a centralized server. The impact sensor is connected to the helmet of the athlete, preferably through a removable connection to a cradle that is permanently fixed to the helmet, or the impact sensor may otherwise be worn on the athlete's head. The impact sensor measures and records an impact occurrence for a high-g impact exceeding a threshold impact level. The mobile application has a prompt screen for entering an athlete's unique Head Sensor identification code, so the associated play-side test will be sent to the appropriate athlete's case file in the centralized server's database. When a coach or trainer is performing a play-side concussion symptom test on the athlete, if the athlete fails any two or more questions, an SMS message is immediately sent from the mobile application to the centralized server. The centralized server then identifies where the mobile application is located and runs a series of background operations, such as Google Queries, to determine the location and suggest or recommend treatment facilities. The concussion symptom test includes response entries to a query prompts which is performed independently from a determination by the impact sensor whether a sensed impact qualifies as a high-g impact. The application performs a concussion risk assessment for the athlete that is associated with the particular concussion risk test. The centralized server has a computer processor, a memory and a communications module. The computer processor controls a database application and an interactive user interface, and the memory stores impact occurrences in association with many respective athletes according to the database application. The athletes correspond to user accounts so that when the centralized database receives an impact occurrence from an impact sensor through one of the user accounts in communication with the interactive user interface through the communications module, the computer processor correlates the impact occurrence with the particular athlete.

In one aspect of the invention, the concussion symptom test is performed without the mobile application necessarily receiving an indication from the impact sensor whether the measured impact is recorded as an impact occurrence and includes an athlete identification field through which the mobile application receives athlete identification information. The concussion risk assessment preferably includes a risk evaluation of the response entries relative to a pass/fail criteria to produce different test results (i.e., cleared, warning, failed) and corresponding messages (notifications & warnings). The mobile application can communicate the concussion risk assessment to the centralized server with athlete identification information, and the computer processor correlates the assessment to the impact occurrence for the identified athlete. In a preferred embodiment, the impact sensor automatically sends an impact warning to the mobile application when the measured impact exceeds an alert threshold and the mobile application can automatically open the concussion risk test with the profile information of the athlete who suffered the impact. A concussion risk notice can be sent to athlete-interested parties who correspond to the user accounts associated with the identified athlete.

In another aspect of the present invention, the computer processor preferably performs a statistical analysis with a comparison of the impact occurrence relative to at least one of an impact history for the identified athlete and a normalized average of impact occurrences for a set of athletes. The comparison is performed by the computer processor relative to a statistically significant threshold and is performed independently from the concussion risk test and risk assessment performed by the smart-phone application. The computer processor triggers an alert notice being sent to the athlete-interested parties when the statistical analysis has determined the statistically significant threshold has been exceeded.

In yet another aspect of the present invention, a concussion diagnosis from a medical professional is recorded in the database for the identified athlete relative to the concussion risk assessment performed with the concussion risk test and relative to the statistical analysis performed on the impact occurrence. The concussion diagnosis may be positive or negative and is analyzed relative to positive and negative concussion diagnoses from many different medical professionals for the respective athletes documented in the database. Also, the corresponding concussion risk assessment and statistical analysis is respectively correlated to concussion risk assessments and impact occurrences to feedback into and incrementally adjust the normalized average and statistical analysis.

### BRIEF DESCRIPTION OF THE DRAWINGS

The present invention will become more fully understood from the detailed description and the accompanying drawings, wherein:

FIG. 1 is a schematic diagram of the system according to the present invention;

FIG. 2 is a flowchart of communication paths for the system shown in FIG. 1;

FIG. 3 is a flowchart of operations performed by the system shown in FIG. 1;

FIG. 4 is an isometric view of an impact sensor;

FIGS. 5A and 5B are graphical displays of the impact data;

FIGS. 6A-6D are screenshots of the play-side test running on an interactive user interface of the present invention;

FIGS. 7A and 7B are tables of the data stored in the database of the present invention;

FIG. 8 is a screenshot of a user sign up screen running of an interactive user interface of the present invention;

FIG. 9 is a screenshot of a user profile entry screen running of an interactive user interface of the present invention;

FIG. 10 is a screenshot of an individual user profile screen running of an interactive user interface of the present invention;

FIG. 11 is a screenshot of an impact analysis screen running of an interactive user interface of the present invention; and

FIG. 12 is a screenshot of a team screen running of an interactive user interface of the present invention.

### DETAILED DESCRIPTION OF THE PREFERRED EMBODIMENTS

The following description of the preferred embodiment(s) is merely exemplary in nature and is in no way intended to limit the invention, its application, or uses.

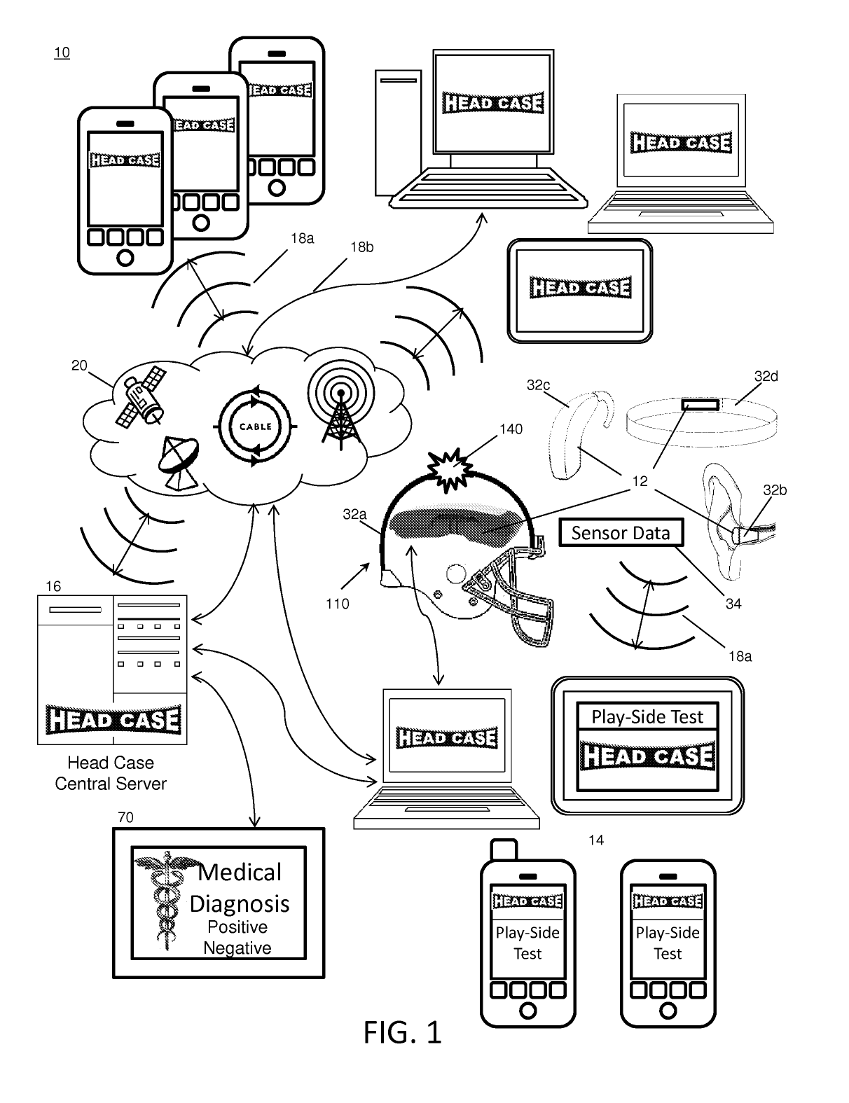

The present invention is an impact sensing, evaluation and tracking system 10 that helps detect concussion symptoms in athletes 100 using a computerized analysis of sensor data 34 that is collected in real-time during play and is combined with traditional concussion evaluation methods which are improved using computerized tools according to the present invention. The inventive system 10, generally referred to herein as the Head Case system, is illustrated in FIG. 1 as a multi-platform system that integrates impact sensors 12, a smart-phone mobile application 14 and a centralized server 16. The system uses interactive communications 18 between the devices through a communications network 20 to transmit and receive information, set and update threshold levels, provide warnings, create and modify profiles, and the other system tasks as described in detail below.

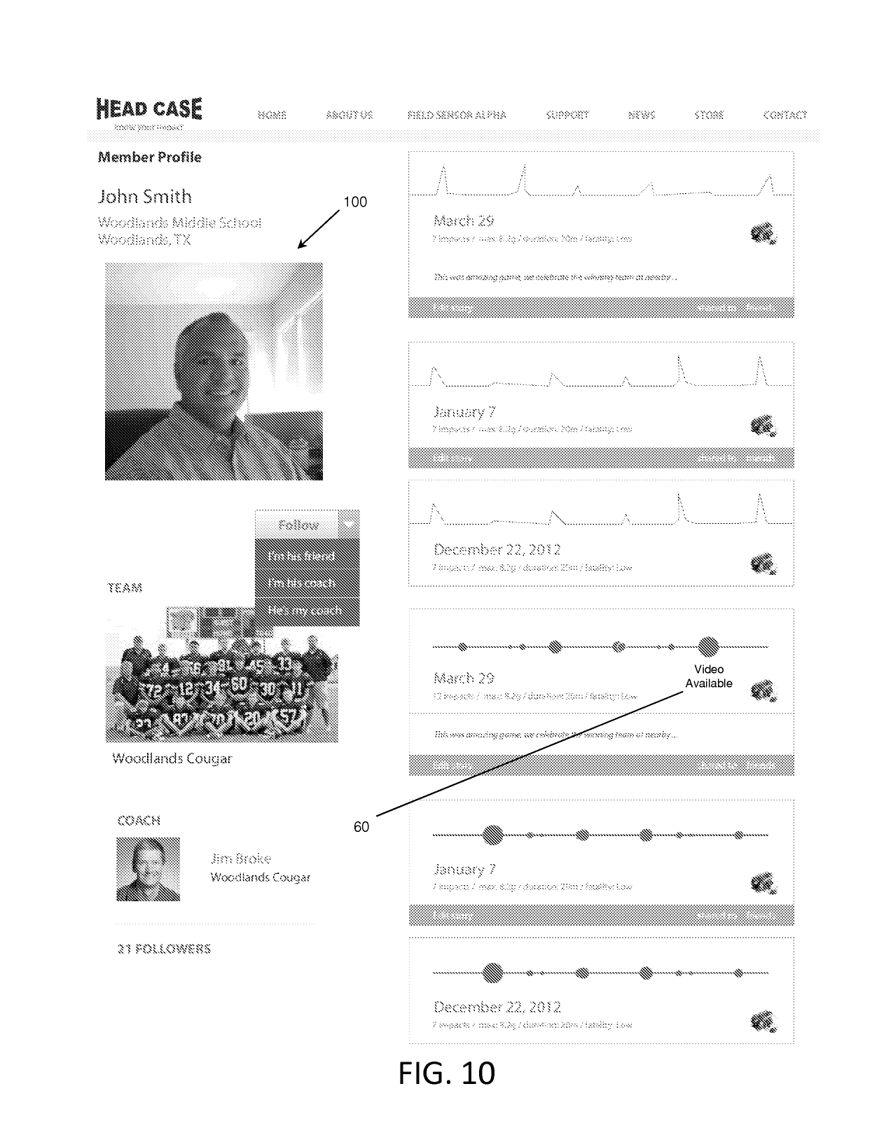

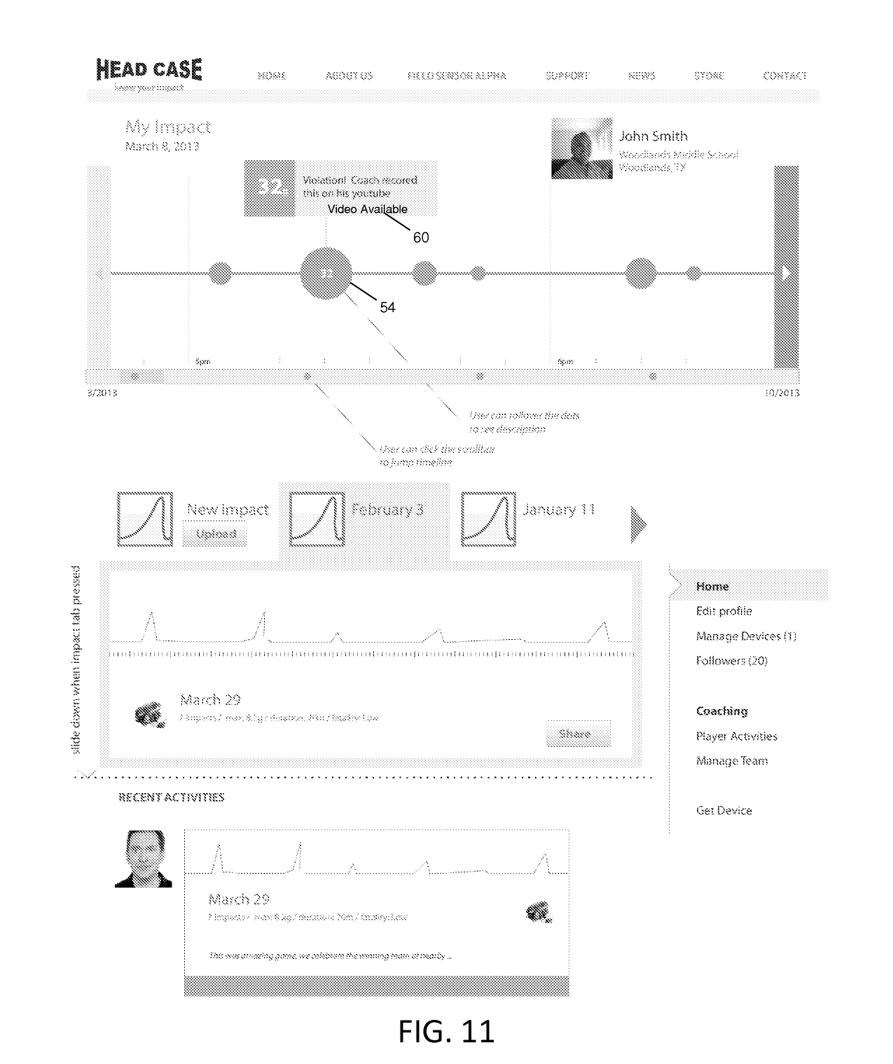

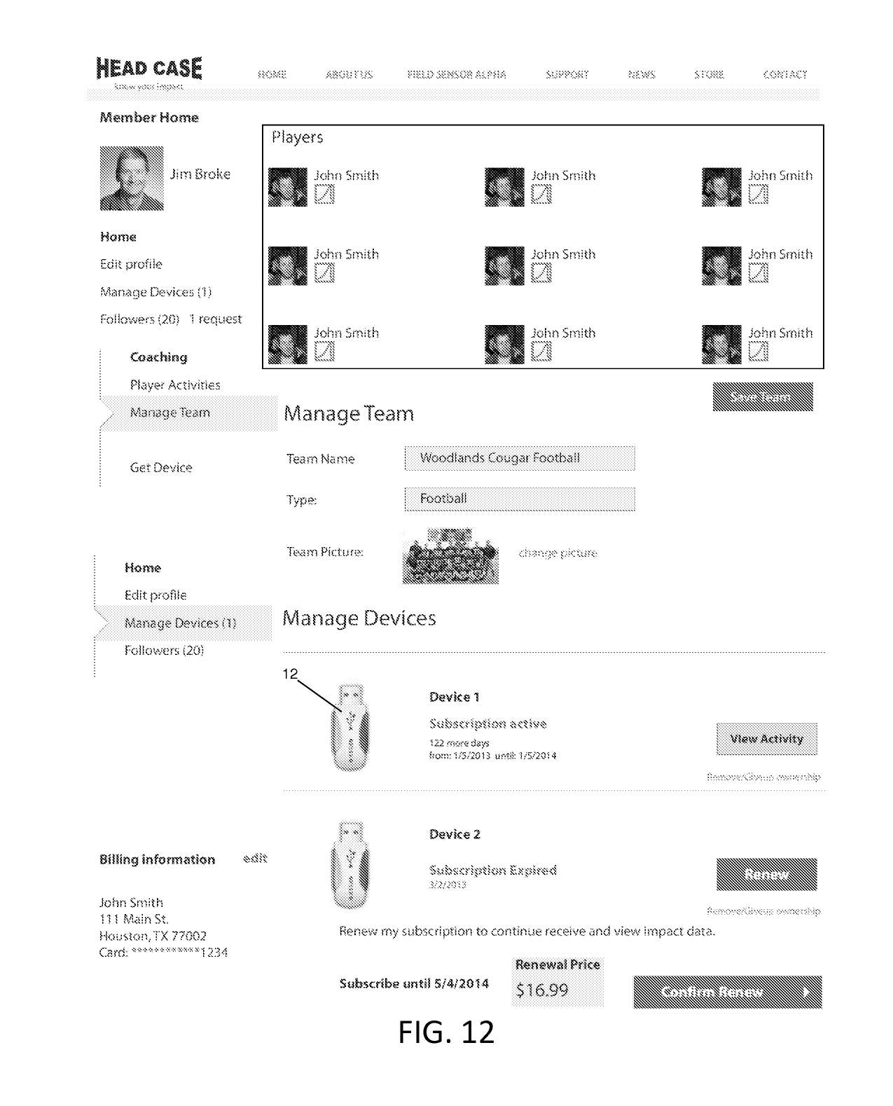

Generally, the centralized server 16 has a computer processor 22 that communicates with authorized system users 130 by an interactive user interface 24 through a communications module 26 and runs analytical tools on the information stored in the server's memory 28 with a relational database 30. The interactive user interface 24 can be any type of analytic dashboard, such as shown in FIGS. 10-12, that may be displayed by a smart-phone screen, a tablet screen, an eyewear display, a webpage browser interface, or any other computer interactive graphical interface. The system 10 provides authorized users 130 with continuous access to real-time test results, analyses of particular impacts 140 and cumulative historical data and diagnoses of concussions for athletes 100. An overview of the system 10 is provided below, including each of the features that is used in the system along with a brief description of the implementation of the system, and is followed by an overview of the system processes and then more details on each of the features and optional processes in implementing the system.

The impact sensors 12 are preferably attached to athletic helmets 32a or other headwear 32 and measure impacts that athletes 100 receive to their heads 110 while playing various sports. The smart-phone mobile application 14 includes a real-time concussion risk test and alert system which assists sideline and other play-side help in detecting the symptoms of concussions and providing timely, accurate and standardized notices to the appropriate parties, including medical professionals, and also reports test results to the database for tracking and further analysis. The impact data for each athlete is stored in the database along with tests that have been administered through the application, and the mobile application can access the information that is stored on the centralized server. The analytical tools in the central server are used to review, analyze and compare impact data to standardized information on concussions, and the database stores the impact data and the analyses as a comprehensive, long-term study on diagnosed concussions in athletes. The central server can also perform a statistical analysis to evaluate the impact data and corresponding concussion information to evaluate impact severities and concussion risks in specific situations. In building the statistical model, the system links diagnosed concussions back to the impacts that caused them and the corresponding preliminary play-side tests as well as those impacts that may have caused particular concern to play-side help or had an impact that significantly exceeded some threshold value but a further examination by a medical professional ultimately determined that the athlete had not suffered a concussion.

The smart-phone application is particularly useful to play-side helpers who have been authorized by the system to conduct a preliminary test of an athlete when they witness a hard impact and/or physiological signs exhibited by the athlete or otherwise have a concern that the athlete may have some risk of a concussion. Play-side helpers may be parents, coaches, trainers who may not be qualified to render a diagnosis of a concussion or could be medical professionals such as medics, nurses, physician assistants or doctors, some of who may be qualified to diagnose a concussion. Although many play-side helpers may not be qualified to render a concussion diagnosis, their combined experience, particularly the experience of coaches and trainers who have seen dozens and possibly hundreds of concussion occurrences during their careers, allow many of these people to recognize the tell-tale patterns of the physiological signs exhibited by athletes suffering from a concussion. Similarly, although many medical professionals know the medical techniques used to determine whether an athlete has suffered from a concussion, they may not have the experience of the play-side help and their knowledge of the players' normal behaviors to make a real-time determination that a particularly hard hit or a fall may have more risk of a concussion or that an athlete's post-impact play may be indicative of a potential concussion. Accordingly, the smart-phone mobile application produces test screens with query prompts that guide the user through a preliminary test of the athlete's neurologic condition. When the user completes the test with response entries to the prompted inquiries, the smart-phone mobile application evaluates the responses relative to a baseline and provides the user with guidance on whether the athlete can continue play or should be removed from further play and possibly sent immediately to a medical professional for further care.

The present system also recognizes that although some play-side help may have naturally gained the pattern recognition skills to notice the signs of a potential concussion, prior to this invention, there had been no efficient way to transfer some objective criteria that can quantify particular impacts that had caused these helpers to pull an athlete from play, either a game or practice, for further examination nor had there been a standardized report of the play-side help's initial evaluation that is linked to the athlete which could otherwise be helpful to the medical professional in a later examination. Accordingly, in addition to guiding the user when administering the test and performing the analysis, the smart-phone mobile application can also produce standardized reports that are submitted to medical professionals with background information on athletes that present for their respective medical evaluations.

The system is also designed with the understanding that it is possible that play-side help could miss the signs of a concussion in an athlete or the athlete may not show symptoms until after a practice or a game, and only later may a concussion be diagnosed. With the present invention, even if a concussion is diagnosed later, the system feeds back the information to the athlete's profile that is stored in the system, and the system can search the athlete's impact data for the impact that could be the most likely cause for the concussion and may identify it as the probable concussion-producing impact. As discussed in detail below, the sensor data is recorded as an impact occurrence 34 which has impact data 34a assigned with time and date stamps 34b so that when the play-side help is notified that there had been a concussion-producing impact which had gone undetected during play, the play-side help can go back to the impact data and their videos and review the particular event(s) with the probable concussion-producing impact(s) as well as later plays involving the athlete to determine whether there may have been some tell-tale signs that may have been missed at the time. The time stamps allow the play-side help to correlate the impacts with playtimes and narrow down those impacts most likely to have caused a concussion.

Without the present invention, there would be no way to identify a particular event for the play-side help to go back and review for any evidence of a concussion. Even if the play-side help were to examine the video of an entire game for such evidence, it is possible that nothing is evident to the reviewers even on a second look so there is nothing to help train the play-side help on what they may have missed. In comparison, with the present system, when play-side help is given particular playtimes in which to be especially attentive, they will be more likely to make a mental note of the incidents during those times which may appear to be more likely the cause of the concussion. It will also be appreciated that there could be multiple impacts during a single game that may have been compounded and contributed together to the concussion, and the reviewers would have no assurance that one or more particular impact occurrences were the likely cause of the concussion. With the assistance of the present invention, the play-side help is given objective evidence about particular suspect impacts that may help them understand what they may have missed in real-time action but may clearly notice in the videos, thereby helping them improve their natural pattern recognition skills. Additionally, as discussed in detail below, if the corresponding videos of the times in question are made a part of the record in the centralized server, it is possible for authorized users of the system and custodians of the athlete data to provide assistance to the play-side helpers in identifying particular aspects of a hit or a fall that more likely than not contributed to the concussion.

The information and analytical tools in the centralized server are made available to authorized users who may be custodians of particular information for one or more athletes or to researchers who may use the data for a variety of purposes. Authorized custodians could be the athletes themselves as well as parents, coaches, trainers, athletic directors, league officials, medical professionals and anyone else who may have a reason to review the information of one or more athletes. Of course, given the sensitive nature of healthcare data records, the amount of information and authorization permissions provided to a particular user will depend on their custodial level. Therefore, while an adult athlete or a parent of a minor may have full access all of the data and information regarding their records with the necessary permission to authorize a particular medical professional to evaluate all of the data and information in rendering a diagnosis, the adult athlete or parent may retain their right to withhold sensitive information from the coaches or trainers. However, to protect injured athletes in time-critical situations, when the preliminary test from the smart-phone mobile application determines that an injured athlete should immediately be evaluated by a medical professional, the terms of use for the system can include a limited release by the adult athlete or the custodial parent(s) with rights to the athlete data which grants consent to any qualified medical professional who has taken responsibility for the care of the injured athlete to access the records directly from the system or through any custodian with access to the system.

In addition to custodians who would have particular interest in athletes in their care, it is also anticipated that researchers who are interested in understanding and generally protecting against head injuries, particularly concussions, will want access to the information contained in the database. In addition to impact data, depending on their particular areas of research and interests, researchers from different backgrounds are likely going to want corresponding concussion diagnoses and play-side help test results. For example, researchers may be in the government, universities, sporting associations (governing bodies or leagues) and even in businesses within the sporting goods industry. Researchers in government may want all of the information as well as demographic information to help focus public service announcements and other messages about sports safety and head injuries or to predict the effect of head injuries on future healthcare costs. Researchers in universities may also be interested in the same information as the government researchers for similar reasons, possibly working with the government researchers in certain cases, but may also want to view the proprietary analytical tools and statistical analyses of the system to compare with their own analytical models. Researchers working with sporting associations and leagues may be more interested in refining the thresholds and criteria used in the system as well as new analytical models for the system to use in the evaluations or to support league decisions when defining new rules of play that are intended to reduce the risks of head injuries or to train play-side helpers in the league on some of the most evident physiological manifestations of concussions that they should be watchful for in the athletes during play. Researchers working with helmet manufacturers may be most interested in the impact data as they work with engineers to design helmets with improved safety features, and some of the preliminary test information may also be helpful.

In performing their research, the researchers may want details about the athletes. However, due to the sensitive nature of healthcare data records and privacy laws, rules and regulations, it may not be possible to provide the researchers with personal identifiable information (PII) in the athlete data. Therefore, information that is made available to researchers can be aggregated without the PII or otherwise anonymized or genericized down to the individual level to remove the PII and replace it with generic identifiers that do not specifically identify individual athletes or their schools or teams (i.e., generic identifiers can be used for names of athletes, schools, teams, etc.). Some researchers may be more interested in demographic information than the PII, because the demographics are more useful in normalizing or otherwise standardizing and correlating the data for all of the athletes in the database. Accordingly, demographic information can include the type of sport (football, soccer, field hockey, etc.), the player's position on the team when injured (quarterback, guard, goalie, forward, etc.), age, height, weight, gender, ethnicity, type of play and impact description (kickoff return tackle, open field tackle, blind-side tackle, rebounding in-air collision, fall after jump, heading ball/head collision, penalty box or corner kick collision, etc.). Additionally, demographic information may also include information about the athlete's school or team and its relative ranking within a league, and all of this information can be anonymized.

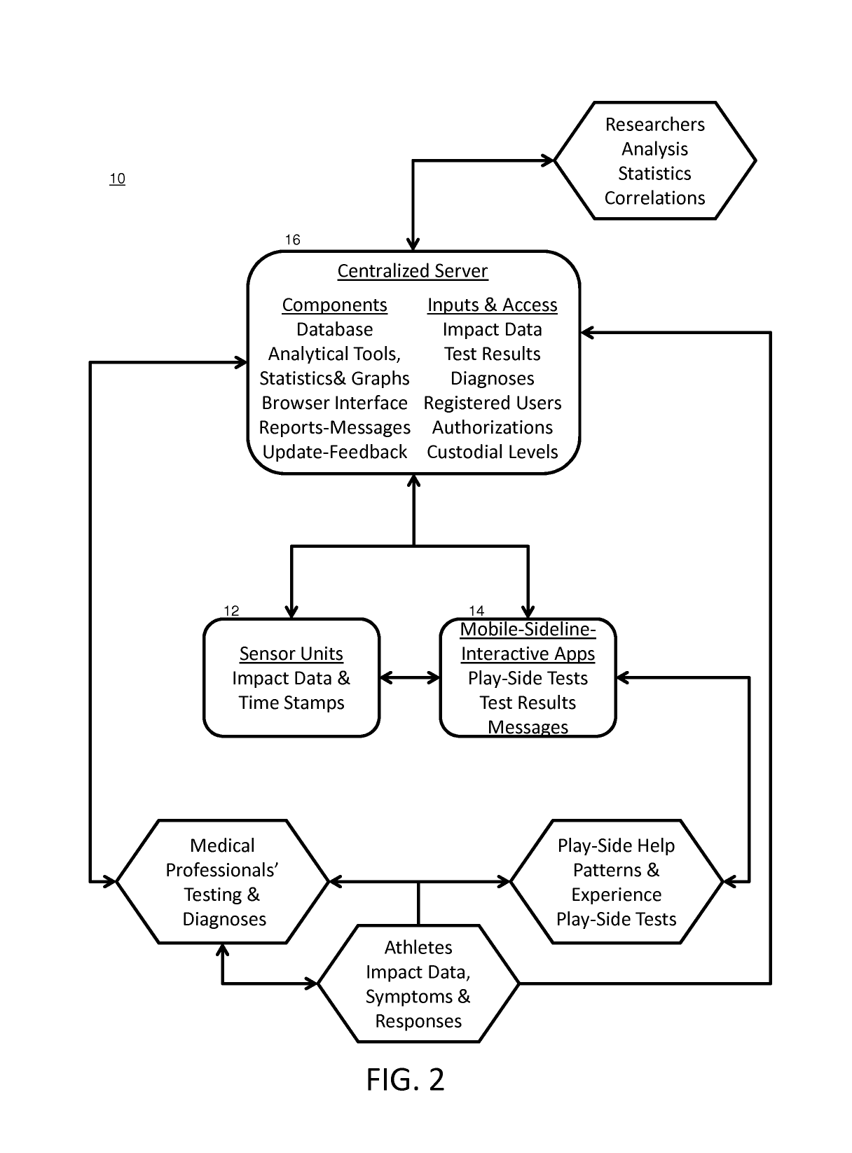

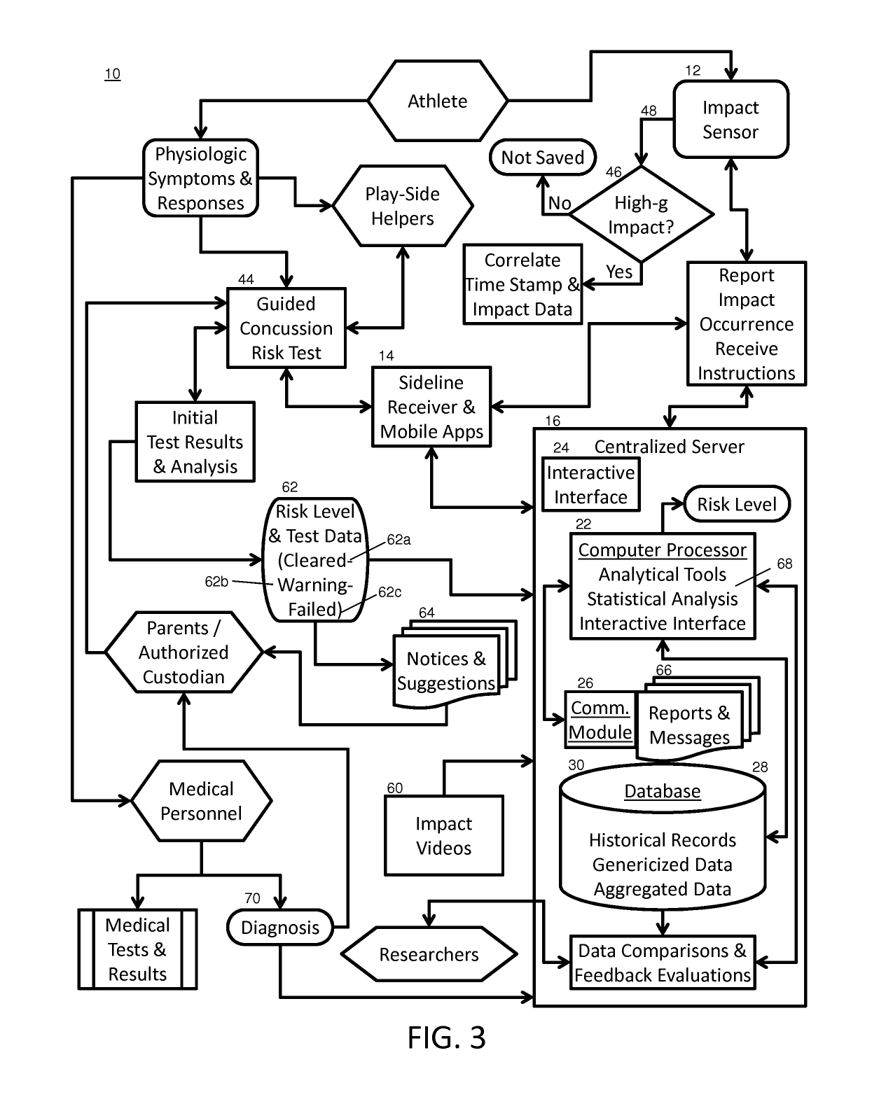

The communication paths and operations of the system 10 are shown in the flowcharts of FIGS. 2 and 3, respectively. According to the general operations of the system 10, the centralized server defines and updates the threshold impact level in the impact sensor to trigger the recording of impact data. The threshold impact level can be based on a number of factors, including the cohort of an athlete based on demographic information and possibly the sport and use or absence of a helmet. The centralized server can also correlate impact occurrences with corresponding sets of concussion risk assessments and concussion diagnoses to determine, set and update the alert thresholds for an individual athlete or a similarly situated cohort of athletes. The centralized server can instruct the impact sensor to trigger a warning when the impact occurrence exceeds the alert threshold.

The centralized server stores the impact occurrences in association with a plurality of respective athlete accounts in its database. The server also correlates videos that show the impacts to the heads of athletes with the sets of impact occurrences. To help with the correlation, the impact sensor applies a date and time stamp to each impact occurrence that it records, the server preferably synchronizes the date/time stamp used by the impact sensor and correlates the date/time stamp with the local date and time used by the mobile application.

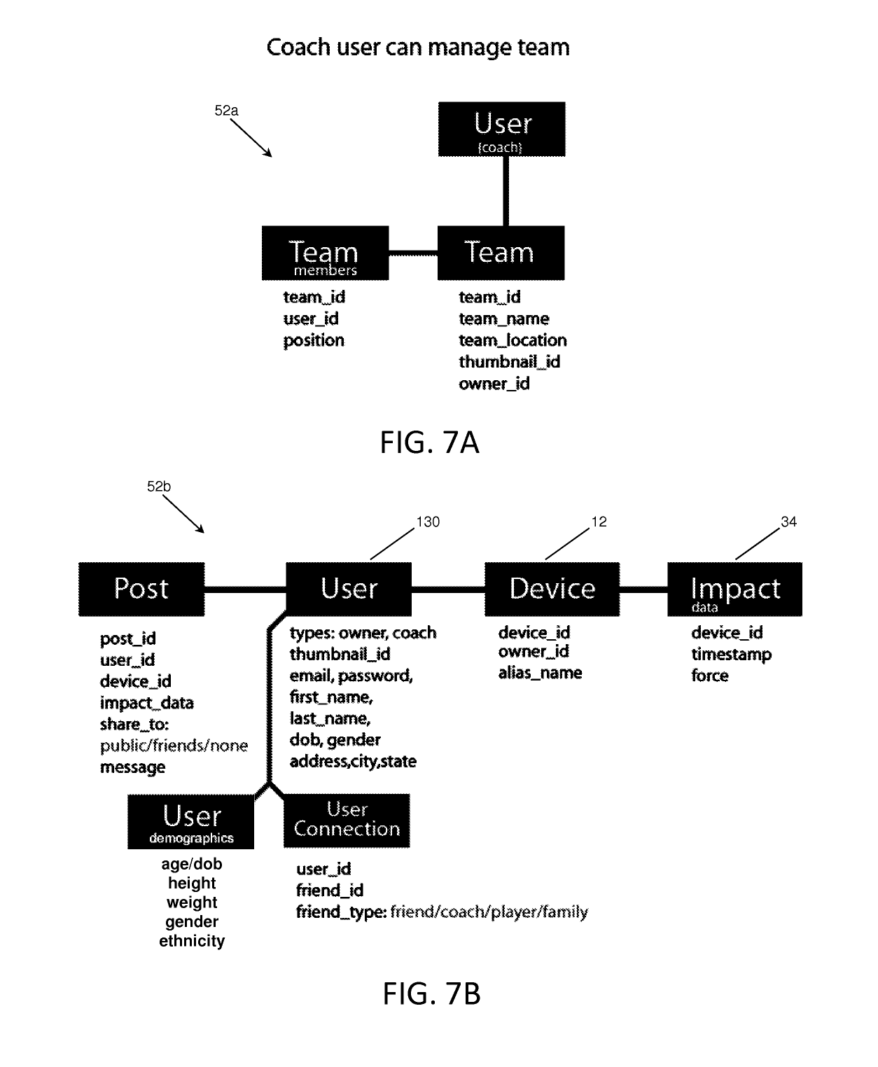

The centralized server associates each athlete's account in the database with the athlete whose impact data, profile information, videos, and other information are being managed and tracked under the account. As shown in FIG. 7B, the centralized server also associates the device identifier for the athlete's impact sensor with the athlete's account and associates the athlete's account to other users accounts which are given varying levels of authorization to query certain information in the athlete's account, such as parents and other family members, coaches, trainers and other team members, other athletes and friends. When the centralized server receives the impact data from a particular impact sensor registering an impact occurrence, the computer processor stores the impact data in the database for the appropriate athlete's account, i.e., the account associated with the impact sensor.

Regardless of whether the impact sensor registers an impact occurrence or sends a warning notice, the play-side help can use the mobile application to perform the concussion risk test on the athlete. As described in more detail below, the mobile application determines the concussion risk assessment for the athlete based on criteria stored in a knowledge base for the particular concussion risk test. The mobile application uploads the concussion risk assessment to the athlete account in the database, and the centralized server correlates the concussion risk assessment to the most likely impact occurrence in the database for the athlete account which corresponds to the test.

In some cases, the impact sensor and the mobile application may have already identified the impact occurrence which corresponds to the concussion risk test and its assessment. For example, when the impact sensor is triggered by an impact that exceeds an alert threshold, a warning notice may be automatically transmitted by a wireless transmission to the mobile application along with the impact data for the impact occurrence, the mobile application may automatically launch the test for the particular athlete whose impact sensor had triggered the warning. In other situations, there may have been no trigger, and in this case, the centralized server may evaluate the time stamps of several hits within a certain time period preceding the time when the test was conducted and may further evaluate the levels of the impacts relative to each other; the centralized server may correlate the concussion risk assessment to the single highest impact during this time period or may correlate the assessment to a particular set of the impacts. In those cases in which an alert threshold is exceeded and the impact sensor generates a warning, the mobile application and/or centralized server can communicate the warning to the authorized custodians associated with the athlete's account. The system may also alert authorized play-side helpers at a particular location that corresponds with the position where the impact sensor triggered a warning or where the test was taken, regardless of whether these helpers are associated with the athlete's account.

The impact data is repeatedly collected from the impact sensor along with one or more concussion risk assessments that may be performed with the athlete. This information is associated with the athlete account and stored in the central database to create an impact history for the lifetime of the athlete's sports career. Additionally, the database may also receive one or more concussion diagnoses for the athlete. Similar to the correlation of the concussion risk assessment to an impact occurrence, the central server may try to determine one or more impact occurrences corresponding to each concussion diagnosis. In the event that one or more concussion risk assessments had been performed a relatively short period of time, such as less than a couple of days or a week. prior to the concussion diagnosis, in addition to comparing the date of the diagnosis relative to date and time stamp of the impact occurrence and the relative size of the impacts, the central server may also evaluate the assessments during the time period.

The central server uses the histories of many athletes to create one or more normalized averages of impact occurrences for various sets of athletes according to particular athlete cohort demographics and sports. The central server performs a statistical analysis by comparing an impact occurrence relative to the impact history for the athlete and may also perform a statistical analysis using the normalized average for the athlete's cohort. In the preferred embodiment, the central server also has feedback loops in which it evaluates multiple concussion risk assessments, impact occurrences and concussion diagnoses relative to the normalized average for one or more athlete cohorts and the statistical analysis for the athlete and adjusts the normalized average and statistical analysis to better predict the likelihood of a concussion from the impact to the head of an athlete. Also, by relating the impact occurrences relating to the concussion risk assessments and corresponding concussion diagnoses, the centralized server can determine the general alert threshold within a range that will likely produce a warning for nearly most concussions and will also have some percentage of false positives. As indicated above, the central server can send instructions to the impact sensor to update the alert threshold with the general alert threshold.

### Impact Sensor

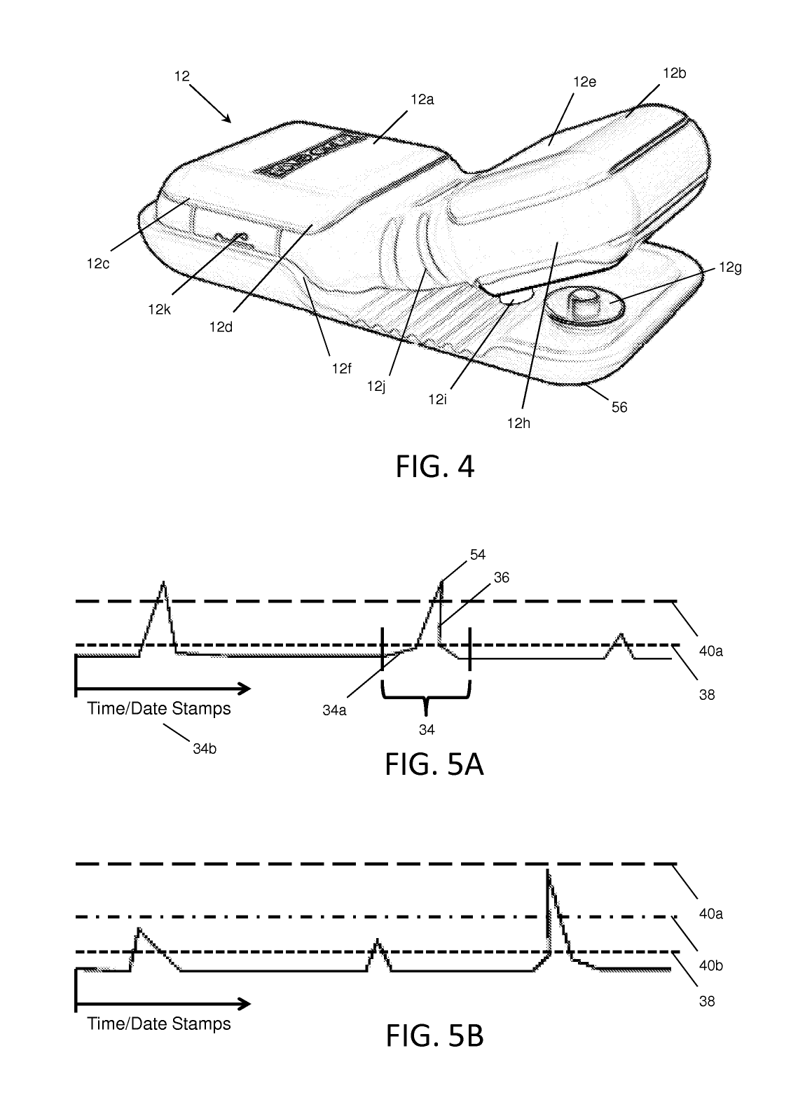

As indicated above, the impact sensor 12 is one of three basic elements used in the design of the system. The impact sensor 12 shown in the FIG. 4 is designed for use with sports that require helmets 32a, and this version of the sensor would be placed inside an athlete's helmet to record the impact data 34a. The sensor 12 is inserted and locked to a cradle 56 that is securely affixed to the helmet. The device and cradle are flexible so they can account for curvature of varying degrees on the inside or outside of the helmet. In one embodiment, the housing 12e of the impact sensor connects to one end of the cradle 56 with a friction fitting 12f and connects to the other end of the cradle with a snap closure 12g. Other sensor designs may be used for athletes playing sports that do not require the use of helmets, such as the in-the-ear buds 32b, around-the-ear hooks 32c and headbands 32d as shown in FIG. 1 and explained below.

The sensor unit has one or more accelerometers, a micro-processor and a memory board which respectively measures the impact 48 and records the acceleration in g-level over a period of time for those impacts 36 that are determined to exceed a certain minimum threshold 38, i.e., a determination of high-g impacts 46, thereby indicating that there may be some potential risk to the athlete which should be uploaded to and evaluated by the processor of the centralized server. For those impact sensors which continually monitor accelerations, it is possible for the impact sensor to record the accelerations a short period of time immediately prior to reaching the recording threshold as well as a period of time immediately after dropping back below the recording threshold. The micro-processor may be programmed to only record those impacts that are clearly beyond the ordinary play of the athlete. For example, athletes wearing helmets may ordinarily experience accelerations up to 10 g without significant risk of head trauma or injury, and the sensors can be programmed to only record those impacts that exceed the 10 g threshold level. However, it is possible that when athletes are playing sports without helmets, a lower threshold may be advisable, and the present system allows for modifying the threshold level accordingly. The sensor preferably stores the date and time corresponding with the impact data and transmits the impact data and time stamp together to define the impact occurrence. Graphical displays of the impact data with time stamps are showing in FIGS. 5A and 5B.

A rechargeable lithium-ion battery powers the sensor unit, and the sensor unit also has a communications module 12h which may be a hard-wired feature or a wireless communications protocol. The accelerometer and battery sections are preferably arranged on opposite sides of the flexible center section 12j and are electrically connected through its interior portion. The data recorded by the sensor can be transferred to partner devices that are operating the Head Case system software by connecting the sensor unit through a mini-USB cable in the USB port 12k. These partner devices could be any type of computer device, including smart-phones, tablet computers, laptop computers or desktop computers, and can also provide recharging capability. The impact sensor's battery can also be recharged through an AC outlet adaptor.

The housing of the sensor unit and the micro-USB port are moisture resistant to withstand light rain and perspiration. The Head Case logo element or some other feature displayed on the external side of the sensor unit can serve as a battery status indicator which is lit when the battery is in its cradle being charged or may flash when the battery's power level is low, indicating that the battery needs to be charged. When the sensor unit 12 is securely locked into and engaged with the cradle 56, a button/tab switch 12i is depressed which puts the unit into record mode and any high-g impacts will then be recorded and stored on the device until the impact data is uploaded to the database in the centralized server and the sensor unit's memory is reset so that the prior data is cleared before the sensor's next use. When the tab disengages from the cradle, the switch terminates the recording mode. It will be appreciated that the button or any type of fitting that engages the cradle can be used to initiate the sensor's record mode.

Preferably, the sensor unit uses a single impact sensor and has a unique sensor identifier within the system; accordingly, when an alert threshold 40 is exceeded and a warning or other alert 54 is produced, the sensor identifier is also communicated to the mobile application which identifies the athlete corresponding with the alert or warning. The sensor is preferably an omni-directional accelerometer which collects the data for the three variants of the X, Y, and Z axes. The sensor can also be formed with one or more linear accelerometers to measure the axial acceleration of the athlete's head 120 with one or more angular accelerometers to measure the rotational acceleration of the athlete's head. As evident from the illustrations showing the impact data, the sensor can store a certain amount of impact data leading up to the threshold value as well as impact data following the high-g impact occurrence as the g-level drops below the threshold value to the baseline level. The sensor includes an impact evaluation circuit to compare the impact data relative to the threshold level. The system can use a wireless transmitter to communicate the impact data from the sensor but this is not necessary for the system to work. Wireless technology could be used to transmit impact data to the central server, such as directly through mobile phone data streaming technology, or indirectly by first transmitting the impact data to a smart-phone running a version of the application that can store impact data and then communicate it to the central server. The wireless transmission to the smart-phone may be through a secure local connection, such as through WI-FI or BLUETOOTH communication systems or over radio frequencies permitted for data communications and/or telecommunications.

The wireless transmission may be made in real-time or near real-time. For near real-time transmissions, the sensor can collect the data and then transmit the data to paired devices in periodic bursts, such as every couple of minutes, a few minutes or several minutes. It is also possible to send out periodic bursts every couple of seconds, a few seconds or several seconds. Using the pairing handshake between the impact sensor and the paired device, it is also possible for the paired device to send an instruction to one or more impact sensors to transmit the impact data. Additionally, in a preferred embodiment of the present invention, a data burst can be triggered after a significant high-g impact. To determine the significance of a collision, a fall or other impact, the sensor can be programmed with additional threshold values, such as one or more alert thresholds. When the impact evaluation circuit determines that the impact data has exceeded certain alert criteria, it triggers the transmission of the impact data and may also transmit the particular alert criteria to identify the threshold that had been exceeded.

The system preferably sets one alert criteria and corresponding threshold based on general criteria. For example, a general alert criteria for athletes can defined based on the demographic factors of similarly situated athletes in their particular cohort; the system can evaluate the collective historical impact data for the cohort relative to the results of play-side tests and concussion diagnoses to set the alert threshold at levels which show that there are increased statistical probabilities of some cognitive impairment and/or potential concussion. Another alert criteria can be set based on a unique criteria for each individual athlete, such as an individual threshold that has either resulted in an impact event 58 for the athlete, such as a “failed” play-side test and/or a diagnosed concussion, and when no such event has occurred, a threshold that is set based on other historical impact data for the athlete or a likely impact event based on a general alert threshold 40a. For example, the individual alert threshold 40b may be set at some level greater than the highest historical impact for the athlete or at a level that compares a set of the athlete's impact history with similarly situated athletes in the cohort who have had an impact event to predict the statistical probabilities based on the individual as situated within the particular cohort. Accordingly, the impact sensor of the present invention is a smart-sensor which is taught by the system those impact occurrences which are more likely to be an impact event of particular concern compared with those impacts which are not likely to cause a concussive event. In particular, as described in detail below, the centralized server performs evaluations of the athlete's impact data and other athletes' impact data, determines the threshold settings for the sensors and communicates the threshold settings to the impact sensors, such as through the mobile application or possibly directly from the server. These settings can be set at general levels for various sports and other athlete demographic criteria and can also be set for the individual athlete based on the historical impact data and other information stored in the centralized server's database. The most similarly situated athletes in the cohort would also have had no impact event at the same impact levels in which the individual athlete has had no impact event and would have had an impact event at some elevated level to which the individual athlete has not yet been subjected.

Even though the impact data can be wirelessly transmitted in real-time and the impact data can be immediately uploaded to the centralized server, the inventive system may not necessarily perform a real-time analysis of the impact data to avoid interfering with the dynamic of the play in a game or practice. Accordingly, the present invention can be designed to allow sports to be played as intended without unnecessary interruptions caused by false positives while also improving the safety of play by providing better tools to play-side help, medical professionals and researchers. When the system is configured to perform a real-time data transfer and analysis, such as by the impact evaluation circuit in the impact sensor alone or in combination with the mobile and/or server applications, depending on the severity of the alert threshold that has been exceeded, the system may wait a short period of time to give the play-side help an opportunity to launch the concussion risk test through their smart-phone mobile application. If the play-side help does not launch the test, the system would send a message to the helpers associated with the player at issue that the test should be administered. After a critical alert threshold has been exceeded indicating that a high risk impact has occurred, there may be no delay in the alert.

As indicated above, the impact sensor is designed to be used in conjunction with the analytical tools provided by the centralized server so that the data is properly evaluated and interpreted. When the user plugs the sensor unit into a computer via the micro-USB, the Head Case software extracts the latest data set of impacts and uploads the extracted data to the database in the centralized server. This transfer of impact data can also occur through the wireless transmission as described above. The authorized custodians of the athlete's data are designated within the system according to athlete associated with the unique identifier on the sensor unit that had been in the helmet of the particular athlete. These athlete and authorized custodians can see the uploaded impact data in relation to the athlete's impact history and can also view comparative data that is based on the impacts of other users. If there are impacts of concern, such as g-levels that are extremely outside of normal parameters, the affected athlete and custodians corresponding with the athlete, including parents, coaches and trainers, will be encouraged to get an evaluation and diagnosis from a medical professional. Additionally, notifications of the impacts of concern are also preferably sent to a predetermined list of caregivers and emergency contacts who are authorized in the athlete's profile within the system to receive such notifications. For example, a parent, guardian, coach, trainer, administrator, doctor and even a friend may be listed and these authorized recipients would be sent a message, preferably via a text or e-mail.

The impact sensor is preferably small and light, comparable to the size and weight of a small thumb drive and could use a single omni-directional sensor as described above or may be a multi-sensor array, such as a combination of linear and angular accelerometers. Accordingly, as described above, one or more linear and/or angular accelerometers can be used for the impact sensor. The impact sensor is preferably semi-permanently or removably attached to one or more cradles that would be glued into each helmet that an athlete may use for one or more sports, or the impact sensor can be incorporated into one of the other headwear designs suited to sports which do not use helmets. For use with helmets, athletes are encouraged to mount cradles in each of their helmets so the impact sensor can be moved from helmet to helmet, sport to sport, so that impacts to the head of an athlete is always being monitored. By designing the system to have a cradle fixed to the helmet which semi-permanently or removably holds the impact sensor within the helmet, there is a reduced cost of the system components as compared with other systems which fix sensors directly to helmets. In these other systems, the cost of the sensors is additive to each helmet used over the career of the athlete. Therefore, in these other systems, when a youth athlete grows out of one helmet with sensors, a different helmet with other sensors must be purchased. Also, when athletes play different sports which use helmets, prior systems would require each one of the helmets to have their own sensors permanently fixed to the helmets. In comparison, the present invention allows an athlete to use one impact sensor throughout their sports career and can even use the one impact sensor amongst the athlete's several helmets for different sports.

It is also possible that an athlete may play a sport in one season that requires a helmet and may play a different sport in another season that does not require a helmet. It would be beneficial for the impact sensor to be modular so that it can be incorporated into either a helmet-mounted version or another article of headwear. Accordingly, a modular impact sensor would be most beneficial which can be secured to the article by standard fittings. As indicated above, the impact sensor may be an in-the-ear sensor, such as an inner ear bud which would not substantially block the sound waves entering the ear, in which case this design could be used for any sport, with or without a helmet. Similarly, the impact sensor can be connected to a headband, an around-the-ear hook or any other headwear worn on the athlete's head 120. For example, sensors can be incorporated into skull caps, mouth guards or other headwear.

### Smart-Phone Mobile Application

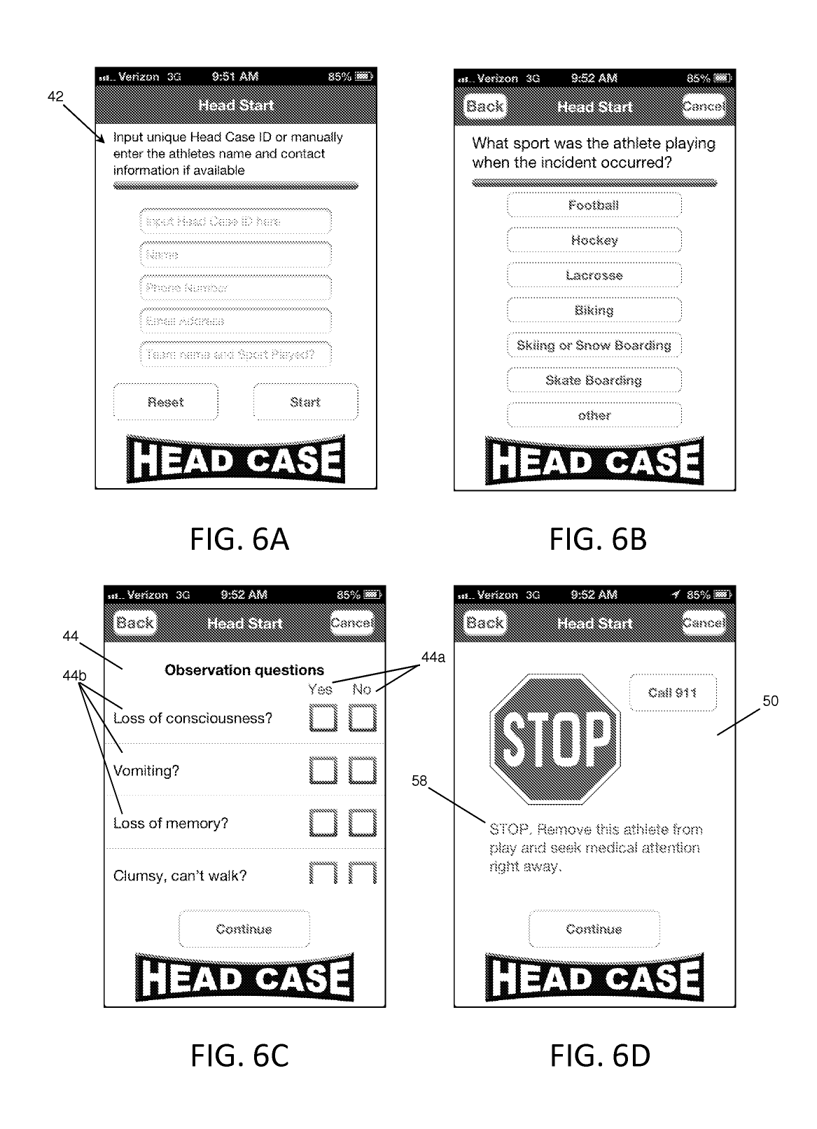

The Head Case smart-phone mobile application 14 serves as a diagnostic tool that provides a prompt screen 42 to guide parents, coaches, trainers and other play-side helpers through an interactive step-by-step play-side test 44 to help detect the symptoms of a potential concussion. As shown in FIGS. 6A-6D, the smart-phone mobile application uses query prompts 44b to assist the system users complete the response entries 44a to document the symptoms of a concussion at home or on the field and can also provide all authorized users with an interface to the corresponding users' profiles and other available information hosted on the centralized server. The play-side test can be one or more of the standardized concussion assessment tools and/or concussion recognition tools that have been developed for assessing and/or evaluating athletes who have been injured while engaged in sporting activities. Additionally, the smart-phone mobile application can be paired with one or more impact sensors to receive the impact data. The smart-phone mobile application can also communicate the impact data to the central server and remotely access the information stored in the central server and can submit updates to the central server.

The smart-phone mobile application preferably includes an interactive user application that allows the authorized users to communicate with their respective user accounts 52 on the centralized server through the server's interactive user interface. The mobile application may also include a sideline application that is designed for managing a team of athletes wearing the impact sensors. In the team environment, the play-side system custodians are preferably coaches, trainers or other medical personnel who have the responsibility for the welfare of the athletes.

The smart-phone mobile application is a separate component of the system that can be used apart from the sensor units and provide a preliminary concussion risk assessment 50 entirely independent from the impact data based on a play-side test that is conducted with the athlete. The smart-phone applications also have wireless communication capabilities to pair with the impact sensors as well as the central server. As indicated above and explained in detail below, even though the mobile application's risk assessment is performed independently from the impact sensors, the system's central server preferably evaluates the mobile application's play-side test results in combination with the impact data and any diagnosis 70 that may be provided by a medical professional. There are a number of existing concussion risk tests that can be incorporated into the mobile application and integrated with the system's server evaluations, including tests created by others such as the Concussion in Sport Group's Concussion Recognition Tool (CRT), Standardized Concussion Assessment Tool (SCAT), Sport Concussion Assessment Tool, version 3 (SCAT3), and the Child-SCAT3. Additionally, iterations of the statistical analyses, test results and concussion diagnoses may result in modifications to known tests or may lead to the creation of entirely new tests. Regardless of the source, the tests are preferably created or modified to be operated through an interactive user interface and include a knowledge base that the processor running the mobile application uses to evaluate the test responses and any other physiological symptoms that are entered into the application to determine the risk evaluation 62 (cleared 62a, warning 62b or failed 62c).

Any user of the smart-phone mobile application can follow the test's preset standard prompts of inquiries and activities that are displayed on the prompt screen 42 for administering the test to an athlete, and the user enters the corresponding responses and entries that the application uses to determine the risks of a concussion. It will be appreciated that although the mobile application will most times be used on a smart-phone, other mobile platforms can also be used to run the application and the risk assessment testing. For example, a tablet computer or laptop computer could also be used to run the mobile application. Authorized users of the system with defined permissions to the athlete's profile can also use the mobile application to access the athlete's information on the centralized server according to the permissions granted.

In the event an athlete “fails” the test, the user is provided with a concussion risk notice 64 indicating that professional medical attention should be sought for the injured athlete. Additionally, the medical attention notice can also be sent to a predetermined list of caregivers and emergency contacts who are authorized in a registered athlete's profile within the system to receive such notifications. As with the high-g impact notice, the notice can be sent through the centralized server via a text messaging system or an e-mail system. In the alert, information on local medical treatment facilities can also be provided to the play-side helpers, caregivers and emergency contacts.

If the play-side test is being administered to a registered athlete in the Head Case system by an authorized custodian of the athlete's data, the centralized server could automatically populate the mobile application with the athlete's impact information and concussion history that is stored in the server's database. The centralized server can determine a registered athlete by several different items of unique information for each athlete, such as the unique identifier from the athlete's sensor, the athlete's team and name, the athlete's e-mail address, the athlete's personal phone number and/or the athlete's individual-level registered user identifier that is created by the system for each person who is registered to use the system. In this case, it is also possible for the smart-phone to receive the contact information for the caregivers and emergency contacts and send the medical attention notice directly to the predetermined list of people.

It will be appreciated that different types of tests can be produced and used with the smart-phone mobile application. For example, one type of test can be a list of prompted questions and other inquiries with response fields for entering the appropriate information. The fields may allow the user to enter free-form text or select from a list of optional responses, such as from a drop-down or pop-up menu, or choose a radio button corresponding with the proper response. There are a number of play-side tests that have been used to aid play-side helpers detect potential concussion symptoms in athletes. One such test is a thirty-question field-side test which has two sets of questions and other inquiries. One set of inquiries is incident-related, reviewing what happened to the athlete as viewed by an observer, and the other set of inquiries are directed to the athlete's ability to provide accurate responses. After the user has completed the play-side concussion symptom detection test with the athlete, the test data is relayed to the Head Case central server where it can be paired with corresponding impact data that is collected from the sensor. The central server can pair the impact data that has a date and time that is close to the time frame in which the test was performed. With the wireless transmission of the impact data to the smart-phone mobile application, it is also possible for the sideline application to pair the impact data with the test data, and the play-side system custodians may even identify the impact data that corresponds with the impact event when communicating the information to the central server.

Other concussion risk tests could also be performed using the smart-phone or other mobile device. For example, some computerized tests are based on visual cues with instructions on how to respond depending on the cue provided, and these tests evaluate the responses from the athlete when a head injury is suspected and compare the responses relative to a baseline test that the athlete would have taken before playing in a sporting event. Another test that may be performed is based on an athlete's voice that is recorded before playing in a sporting event. If it appears that the athlete may have suffered a head injury while playing, the athlete's voice is again recorded and compared to the pre-event recording. The test software evaluates the post-play recording relative to the pre-play recording to check for risk factor indicators of a potential concussion, such as distorted vowels, hyper nasality and imprecise consonants. In one implementation of this test, all of the athletes on a team that may play on a particular day have their voices recorded before play commences, and then all of the athletes that actually played during the day have their voices recorded after the conclusion of the event. In this implementation, the system performs an analysis on every athlete who has played regardless of whether they have presented any symptoms of a head injury or not.

For failed test results, in addition to automatically uploading the test data to the athlete's Head Case file in the centralized server, the system can send the medical attention notice to the predetermined list of caregivers and emergency contacts. The system may perform additional analysis on the test results based on the particular athlete even before the impact data is received, and will then perform the full evaluation and statistical analyses when the impact data is uploaded. Even before the impact data is evaluated relative to the historical data stored in the central computer, the play-side concussion risk test results assist the play-side helpers to make informed decisions about whether an athlete can continue play, suspend play for a period of time, or seek immediate medical attention. Also, as indicated above, the mobile application can also help the users, caregivers and field-side help locate the best treatment facilities for the athlete in the local geographic area. As explained above, the threshold alert from the impact sensor can be based on and updated using the evaluations of the historical and collective impact data performed in the central server, and when combined with the play-side concussion risk test, the system provides a multi-platform integrated evaluation of the impact data in real-time which provides benefits that are not possible by the components working separately from each other.

The sideline application may also be used by individuals who use the Head Case system without any team-level system custodian. For the individual custodian, the smart-phone and sideline applications could be paired to the impact sensor as is done for the team-level system. However, on the individual level, it may be more cost effective for the smart-phone to be paired to the impact sensor through a dongle device. In either event, no special receivers apart from the smart-phone or some other wireless computer, with or without a dongle, is required to receive the impact data from the wireless impact sensors. The handshake and pairing between the smart-phone and the impact sensor preferably uses a low-energy, long-range paired device communication technology, such as the BLUETOOTH communications provided by the BLUEGIGA system. Such a system can pair a smart-phone, tablet or other wireless computer with several dozen impact sensors. An institutional multiplayer system could use the system with the mobile and sideline application to provide notices directly to each one of the play-side help members and to also transmit the impact data to the appropriate smart-phones using either the dongle or the other wireless communication options discussed above.

The sideline application can communicate with the other components integrated into the Head Case system. It can operate in any one of several modes, such as in a harvest mode, a push-pull mode and a bidirectional mode. Additionally, the sideline application can work in combination with the mobile application or directly with the sensors through a dongle or through the inherent wireless capabilities of the sensors and the smart-phone or tablet computer. In addition to having the play-side symptom test in the mobile application, the sideline application can also monitor the power levels and communication status of the impact sensors. Additionally, the sideline application may permit high-g impact notices to be immediately communicated to the play-side help. It is also possible for the sideline application to delay the communication of high-g impact notices to the smart-phones that correspond with the respective impact sensors. The sideline application may provide the immediate alert to the play-side helpers who may then determine when the alert should be communicated to the respective smart-phone. When an impact event is defined within the system, such as by the impact sensor threshold evaluation or conducting the play-side test, the sideline application creates an incident case. In the event that there is a concussion diagnosis, notices are sent to the authorized parties.

### Centralized Server

While the impact sensing device 12 is an important component in the system, it is most beneficial when used in conjunction with the centralized server 16 to evaluate, analyze and interpret the data and in conjunction with the mobile application 14 to perform the concussion risk assessment tests and to have real-time communications with the impact sensor through the low-energy, long-range paired device communications and also with the server when standard wireless communications are available. As described above with respect to the impact sensor, the impact data can be communicated wirelessly and uploaded to the server using the mobile application's wireless communications capabilities or the user may plug the sensor device into a computer via micro-USB to extract and upload the impact data to the server. Regardless of the particular computing and communications devices that are used to interact with the server, the information that is uploaded to and retrieved from the server can be transmitted through any communications network 20, particularly including the internet. Once the impact data and other information is stored in the server, the authorized custodians can review the athlete's impact history as well as results from the system's analysis of the impacts and generic and aggregated data for other athletes.

The athlete's normal impact history is compared to national averages based on impact data collected for other users, the computer processor performs a statistical analysis 68 to detect head impacts of concern and send warnings, notices and other alerts 66 to athletes, parents and other caregivers when statistically significant thresholds are exceeded. As indicated above, the system sends notices to the athlete and the custodians when the analysis indicates that the athlete should be examined by a medical professional, and for impacts of particular concern, the system can also notify a predetermined list of caregivers and emergency contacts. Also, the centralized server can adjust the thresholds for the athletes based on the impact data, the results of the play-side test such as the Sports Concussion Assessment Tool (SCAT), and diagnoses of concussion events.

The centralized server also acts as a resource center for concussion awareness and head health. The system can direct its users to the facilities in their local area that can help athletes who may be suffering from concussions and that can help protect the head health of the athletes in their care. In this regard, the Head Case centralized server is the hub of the concussion management system for athletes. Through the interactive user interfaces, such as web browser and smart-phone application interfaces, the centralized server provides a comprehensive information portal and resource center for concussion education and concussion management. The primary users of the Head Case system are the athletes, their parents and other caregivers, coaches and trainers who may all have user accounts 52. As illustrated in FIGS. 7A and 7B, there are team accounts 52a for coaches, trainers and other managers of teams, and there are individual accounts 52b for athletes and other users. Additionally, the value of the Head Case system will be evident to researchers and may also be helpful to medical professionals who have a particular interest in treating head injuries.

In the event that a medical professional determines that the athlete has suffered a concussion injury, the medical professional will be encouraged to report this diagnosis to the Head Case system so that it can be entered into the athlete's record. Even in the case where the diagnosis is that the athlete has not suffered from a concussion, this information will be sought from the medical professional for reporting in the system. In the event that the medical professional does not submit the diagnosis report, the authorized custodians of such information for an athlete will be encouraged to obtain the report from the medical professional. This feedback from the medical professional will aid in the system producing a better understanding of concussion causing impacts over time. Additionally, such reports will allow the athletes to track their head health according to their access to the system via the interactive user interface which allows the athletes to track any concussions they may have sustained and the dates of the concussions as well as anonymous information accumulated from similarly situated athletes and recommendations for recuperation and maintaining good head health.

The Head Case system uses independent analyses from different sources for the same concussion occurrence, such as the pattern recognition skills of play-side helpers and the information they can enter into the system through the smart-phone application when they witness the signs of a potential concussion-producing impact, the impact sensor real-time threshold evaluations, the smart-phone guided concussion risk assessment test, the impact data analysis in the centralized server, and the medical professional diagnoses (and any reports that the medical professional may enter into the system). This information is uploaded into the centralized server and can be used as multiple feedback loops in which the data and various concussion risk determinations can be compared and evaluated for consistency with each other in making the ultimate determination regarding the athlete's concussion risk for a particular impact or series of impacts. Additionally, the data for each impact occurrence that is analyzed in the system can then be further evaluated by the system's analytical tools relative to aggregated data for other athletes as well as data for other athletes who may be similarly situated to each other based on demographic information.

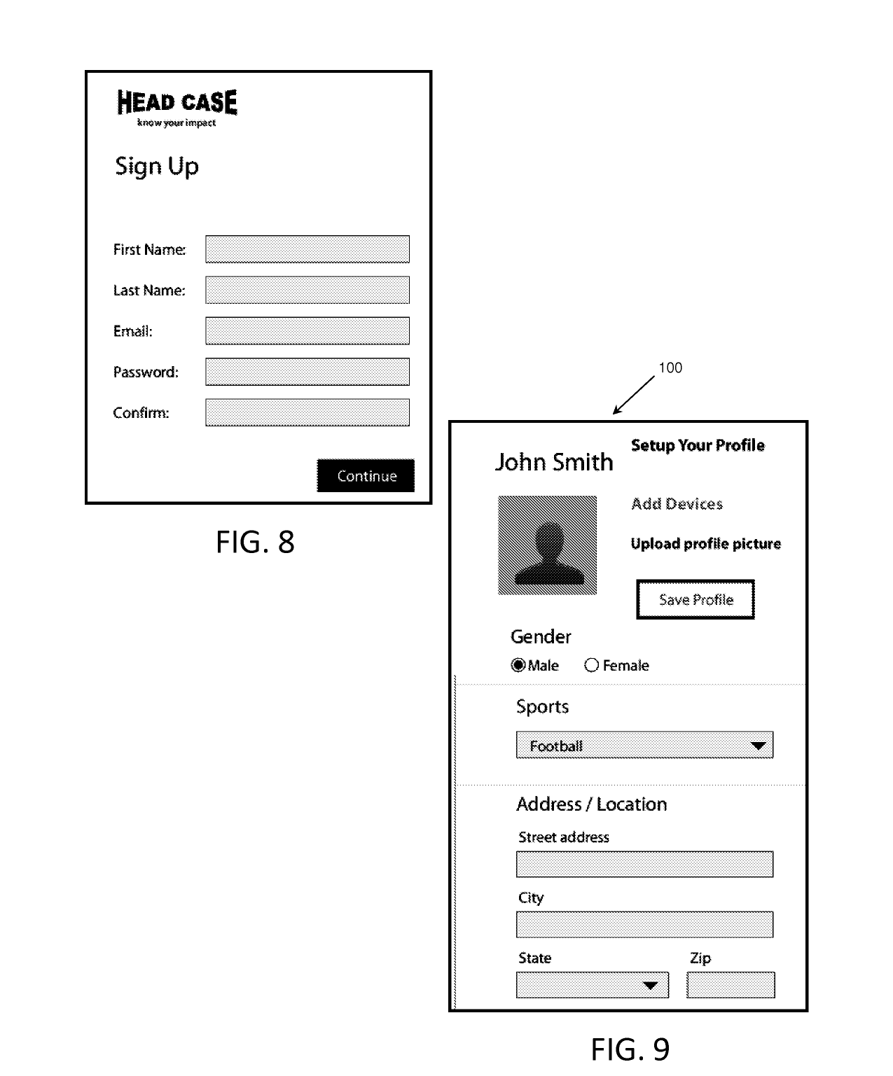

To begin using the impact sensor, an athlete must register it in the Head Case central server with their profile information. As shown in FIG. 8, the user can sign up to use the system using the mobile application to create a user account on the centralized server through the interactive user interface. Similarly, as shown in FIG. 9, the user enters their profile information and can also enter the identification code for their particular sensor.

This sensor has a unique identification code, and all data collected from this impact sensor is stored in the central database for the lifetime of the athlete's sports career. Additionally, as explained above, the data from the smart-phone mobile application and doctor diagnoses are also recorded, tracked and analyzed with the impact data. It will be appreciated that it is possible that one athlete may accidentally use the impact sensor belonging to another athlete or that a school may provide impact sensors for students to use while they are at the school but which remain the property of the school so that the sensors can be reused by different students. Accordingly, the Head Case system can also allow for dynamic linking of athletes to the various impact sensors that they may use for different particular events.

Preferably, each athlete has their own impact sensor so that the impact data can be uploaded to the Head Case central server in near real-time or on a periodic basis, such as daily or weekly. If impact data identifies a statistically significant impact above the individual athlete's or national average thresholds, a secondary alert is broadcast to the identified parties by the user in their profile. As indicated above, alerts suggest that the user should be screened for concussion symptoms and also provide information on local treatment facilities in the athlete's current area. The data collected from the impact sensor and the smart-phone application is stored in the centralized database and is linked to the user's profile.

The Head Case server securely stores and analyzes the athletes' information, impact data and corresponding test results and diagnoses. Athletes and the parents or legal guardians of youth athletes will be able to choose what data, if any, they wish to share for analysis or assistance. However, to protect injured athletes in time-critical situations, when the preliminary test from the smart-phone mobile application determines that an injured athlete should immediately be evaluated by a medical professional or when the impact data is so critical, the terms of use for the system include a limited release by the adult athlete or the parent who has the primary custodial rights to the athlete data which grants consent to any qualified medical professional who has taken responsibility for the care of the injured athlete to access the records directly from the system or through any custodian with access to the system.

Although the custodians of the athletes' data files have final control over the use of any records which include PII, the Head Case system retains all rights and ownership to the aggregated data and anonymized data. Therefore, the Head Case system can provide such aggregated and anonymized data to researchers without violating any privacy rights of the athletes. As discussed above, these various researchers have various interests in this information and would otherwise not have access to this information. Additionally, by providing this information to researchers, the system will have another opportunity to receive another form of feedback which can help further refine and improve its statistical models and analytical tools. As described above, the Head Case system will document and track concussion related data on hundreds of thousands of athletes across the country and around the world with cross-references between different types of concussion risk analyses which will provide a robust databank for further analysis by researchers. Additionally, the Head Case system can provide a forum for the users of the system to communicate with each other.

Given this detailed description of the features of the Head Case system and use thereof by the authorized users and custodians of the athlete data, it will be appreciated that the invention is a full circle concussion awareness, symptom detection, alert notification, impact data analysis and post injury tracking system. The system is designed to help athletes stay safe and insure they do not return to play until they have obtained the appropriate medical clearance. The system provides an end to end solution that will better educate athletes, parents, trainers and coaches across the country and world. Additionally, the ability to tie diagnosed concussions back to the impacts that caused them will be extremely helpful to researchers who are investigating concussions and the ways to protect against them. The system will continue to build a body of impact data with corresponding concussion diagnoses and play-side help test results that better refine the statistical analyses resulting in improved predictions on the risk of a concussion based on the impact data and that better educate and train play-side help in honing their skills for recognizing the types of hits and falls that are more likely to produce concussions.

As described above, the Head Case system synergistically combines three primary elements that communicate with each other and incorporates different data sets and concussion testing protocols so that the cooperative interactions by the system and collective implementation of the system's elements by multiple users are better able to detect concussion symptoms in athletes. When concussion symptoms are detected, the Head Case system alerts the appropriate parties, such as parents, trainers, coaches and league officials, that there could be a potential concussion injury of a particular athlete. In the alert message that the system sends to parents, guardians or other onsite caregivers or responsible parties, the notice can include information on the treatment centers in the geographic area so that the athlete can receive the best care available.

Athletes, parents and coaches review data that is stored on the Head Case central server through any one of the interactive user interfaces using the Head Case analysis and reporting tools. If an athlete's concussion is not detected following an impact during play, the secondary alerting system may deploy to notify parents that they should review the impact data on the website because an impact threshold has been exceeded. An athlete's threshold is preferably determined by a baseline of impact activity created from data recorded by the impact sensor and aggregated data from other athletes, particularly including athletes with similar demographics. As discussed above, the centralized server may use the information it maintains in the database to change the threshold and communicate the new threshold to the affected impact sensors. For example, this may occur during a single season after several impact events have been registered for an athlete or it may change over the span of an athletes' career, particularly as they grow from youth to adult. It will be appreciated that concussions symptoms may not be immediately visible to the play-side helpers following a high-g impact. Therefore, if a statistically significant jump in impact data is recorded and a play-side test either was not conducted (so there is no play-side test result) or was conducted and the test result did not indicate that there was any significant concussion risk, an alert can be sent to parents, legal guardians and/or other authorized caregivers with a recommendation that they either test their athlete at home for concussion symptoms, preferably using the Head Case smart-phone application, or that they have their athlete examined immediately by a medical professional in the event that the impact appears to be critically high.

The Head Case system can maintain contact with the parents and athletes throughout the diagnosis, treatment and recovery process (i.e., medical protocol). Additionally, with the approval of adult athletes or parents or other legal guardians of youth athletes, information received from medical professionals regarding the medical protocol may be fed back into the system for their private records and may also be anonymized and aggregated with medical protocol information for other athletes. When the athlete has a diagnosed concussion, the diagnosis can be registered within the system along with the medical professional's recommendation for the recuperation time without further play. The recommendation can be forwarded to the parents, coach, trainers, league officials and other authorized custodians of the information regarding the athlete to help avoid compounding the injury with more trauma before the athlete has recovered from the diagnosed concussion and to prevent someone from circumventing the medical protocol for the athlete. The Head Case system also provides information to the athlete and authorized custodians throughout the recovery period that can help the athlete avoid concussions in the future. The Head Case system can also provide the latest information about recovery and dangers of returning to play before the entire medical protocol runs its course, particularly including the recovery protocol. Accordingly, the Head Case system includes concussion prevention within its full cycle of concussion awareness.

The Head Case system also provides the athletes and their authorized custodians with analytics and reports on their head injury history and other head trauma across the country and world. With access to the system, authorized custodians can be notified about potential issues or problems in real-time as they happen or can be advised when the analytics in the system have identified an athlete that may be prone to particular dangers or may be engaged in dangerous patterns of behavior, such as indications that an athlete tends to hit with the head. The system can track and analyze for these authorized custodians how many concussions each athlete has had in comparison to the national average, the league, the team or even similarly situated players and teams according to demographic information that can be standardized and correlated.

The system performs statistical analyses on this information and provides risk factors to the authorized custodians to help them make better informed decisions on whether or not athletes should continue playing a sport and their capacity to play the sport without significant risk of additional injuries. The system is designed to provide independent evaluations of the impacts that could cause concussions so that the persons making the decisions on whether an athlete should play or not play is based on objectively factual information rather than subjective fear that may be fueled by false positives that could come from partial information, such as the information as provided by current systems which result in users to unduly relying on computer evaluations of impact data. In the system according to the present invention, concussion-related information begins with the play-side help's immediate observations of the play, the impact itself, and the athlete's response thereto and their skills in recognizing the tell-tale signs of potential concussions, and it also includes the computer analysis of the impact data from the helmet sensors as well as the medical professional's diagnosis and medical protocols.

There is also a feedback loop in the present system which collects and examines the concussion-related information from the real-time observations and immediate play-side tests that have been entered into the system through the smart-phone application, the sensor impact data and computer analyses that have been uploaded into and performed by the centralized server, respectively, and the medical evaluations and diagnoses that have been entered into the system by the medical professional staff. In post-processing examination of the data, the system can include analytical tools that search for statistically-significant patterns in the data and criteria used for thresholds and evaluations and can propose modifications and refinements to the play-side test and the statistical analysis of the impact data and may even be helpful to medical professionals as another one of their diagnostic tools. The analytical tools do not all need to be contained within the centralized server; instead, one of the benefits of the present invention is that the aggregated, anonymized data can be provided to researchers in the government, universities, sporting associations and even in businesses within the sporting goods industry, such as the manufacturers of helmets, who can analyze the data for trends and other patterns with their own independent and proprietary tools and who may use the data to recommend changes to the thresholds and criteria used in the system and may even provide new analytical models for the system to use in the evaluations, or they may find the data to be useful in designing helmets with improved safety features, in defining new rules of play, or in communicating their messages about sports safety and head injuries.

It will also be appreciated that with the ubiquitous nature of smart-phones and the recording of athletic competitions, it may also be possible to link a video 60 of a particular impact that triggered the concern of play-side help. Even if the video had been taken by a spectator or by a video crew who do not have the smart-phone application of the Head Case system rather than one of the play-side helpers, it is possible for the video to be transferred electronically to the play-side helpers. Alternatively, the play-side helper may be able to provide the videographer with a link that is uniquely tied to an impact occurrence for a particular athlete which has been documented in the system and which permits an unregistered user to upload the video of the impact occurrence to the centralized server. The video(s) can be uploaded to the centralized server, and the computer processor can evaluate the time and date stamps on the impact occurrence and the time and date records of corresponding videos to determine matches between the data and video and synchronize the records. Accordingly, the centralized server can store the matched video records in a synchronized relationship to corresponding impact occurrences in the data records which permits the coaches, trainers and medical professionals to study both the data and the corresponding video of impact occurrences which have been found to produce concussions and those that triggered a high risk warning but did not produce a concussion.

While the present invention is particularly designed to help play-side help identify and test for concussion-producing impacts in real-time with the smart-phone application and later analyze impact data independently from the real-time concussion risk tests, it is also possible that the impact data can be wirelessly transmitted in real-time to the central server and analyzed immediately. As statistical analyses of the impact data become more refined and are further evaluated relative to the real-time concussion risk tests performed by particular play-side helpers and the later diagnoses made by medical professionals, it is also possible that even more accurate concussion risk determinations can be made in a real-time analysis of the impact data. Accordingly, it is envisioned that the present invention could ultimately produce such a robust body of impact data and statistical correlations that a real-time analysis can indicate that there is a near certainty that an impact or series of impacts during play will produce a concussion (impact likelihood of concussion, i.e. >90%, >95%, >99% or outliers based on statistically significant standard deviations from a determined norm). With such robust data and refined analysis, if the play-side help has not initiated the play-side test within a set period of time following a near-certain concussion producing impact, the centralized server can send a message to the play-side help that the play-side test should be performed and the athlete removed from play unless a medical professional clears the athlete for continued play.

Although there are more complicated systems which have multiple sensors and complicated computer modeling of impacts as compared with the system described above for the present invention, these complicated systems are generally too expensive for youth sports. However, the largest population of injury occurs with athletes participating in youth sports. The Head Case system is the only end to end service in which the impact data, play-side test results and concussion diagnoses can be maintained for the athlete's lifetime and fed back into a body of information for many such athletes to refine the statistical analyses associated with the information. As explained in detail above, the Head Case system includes concussion awareness and education and seeks to have athletes, parents, trainers, coaches and other play-side helpers to regularly interact with the system. The system also provides medical professionals with impact analysis and play-side testing information pertaining to a particular athlete in a standardized format as well as generalized concussion-related information from the broader database of athletes. Finally, the aggregated data can be used by researchers and other medical professionals to develop better statistical models to evaluate head impacts and their effects on the athletes.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. For example, although the invention has been described with reference to sports and athletes, it would also be realized that the scope and benefits of the present invention are also applicable to military personnel and first responders who may be subjected to head trauma and concussions while performing their operations. Thus, the breadth and scope of the present invention should not be limited by any of the above-described exemplary embodiments, but should be defined only in accordance with the following claims appended hereto and their equivalents.

What is claimed is:

1. A system for monitoring and evaluating an impact to the head of an athlete, comprising:
an impact sensor operatively worn on the head of the athlete, wherein said impact sensor measures and records impact data corresponding with an impact occurrence for a high-g impact exceeding a threshold impact level;
a mobile application comprising a prompt screen for performing a concussion risk test on the athlete, wherein said concussion risk test is comprised of a plurality of response entries to a plurality of query prompts, wherein said concussion risk test is performed independently from a determination by said impact sensor whether the impact qualifies as said high-g impact exceeding said threshold impact level, wherein said mobile application performs a concussion risk assessment for the athlete in association with said concussion risk test; and
a centralized server comprising a computer processor, a memory and a communications module, wherein said computer processor controls a database application and an interactive user interface, wherein said memory stores a plurality of impact occurrences in association with a plurality of respective athletes according to said database application, wherein said computer processor correlates said respective athletes to a plurality of user accounts, wherein said centralized database receives said impact occurrence and said concussion risk assessment and correlates said impact occurrence and said concussion risk assessment with one of said user accounts corresponding with the athlete wearing said impact sensor.

2. The system of claim 1, wherein said impact sensor is selected from a group of sensor units consisting of a helmet-mounted sensor, an in-the-ear inserted sensor, an around-the-ear mounted sensor, and a headband-mounted sensor, and wherein said sensor comprises an accelerometer, a battery, a micro-processor and a data-storage memory.

3. The system of claim 2, wherein said battery powers said accelerometer and said micro-processor, wherein said micro-processor receives a plurality of impact data sets from said accelerometer and determines at least one of said impact data sets exceeding said threshold impact level and correlates said impact data set with a time stamp to define said impact occurrence, and wherein said data-storage memory stores said impact occurrence corresponding with said high-g impact.

4. The system of claim 2, wherein said impact sensor further comprises a wireless communications module paired with and operably communicating with said mobile application, wherein said micro-processor determines said high-g impact exceeds an alert threshold and triggers a wireless transmission of said impact occurrence to said mobile application, wherein said mobile application is further comprised of a sideline application in wireless communication with a plurality of impact sensors worn on and corresponding to a plurality of team athletes, and wherein said mobile application produces an alert identifying the athlete from said plurality of team athletes based on said impact sensor triggering said wireless transmission.

5. The system of claim 1, further comprising a helmet cradle, wherein said impact sensor is removably connected to said cradle, wherein said impact sensor further comprises a switch, wherein said tab initiates a recording mode while engaged with said cradle and terminates said recording mode when disengaged from said cradle, and wherein said impact sensor and said cradle have a pair of adjustable sections connected to a flexible section.

6. The system of claim 1, wherein said concussion risk test is performed without said mobile application receiving an indication from said impact sensor whether said measured impact data is recorded for said impact occurrence, wherein said centralized database receives said concussion risk assessment and correlates said impact occurrence and said concussion risk assessment with one of said user accounts corresponding with the athlete wearing said impact sensor, and wherein said mobile application is further comprised of an interactive user application in operative communication with at least one of said user accounts on said centralized server through said interactive user interface.

7. The system of claim 1, wherein said concussion risk test further comprises an athlete identification field through which said mobile application receives athlete identification information, wherein said concussion risk assessment is further comprised of a risk evaluation of said response entries relative to a pass/fail criteria to produce at least one of a cleared test result, a warning test result and a failed test result, wherein said mobile application communicates said athlete identification information and said concussion risk assessment to said centralized server, wherein said computer processor correlates said concussion risk assessment to said impact occurrence for said identified athlete, wherein a concussion risk notice is sent to authorized custodians corresponding to said user accounts associated with said identified athlete through at least one of said mobile application and said centralized database when at least one of said warning test result and said failed test result has been produced.

8. The system of claim 1, wherein said computer processor performs a statistical analysis with a comparison of said impact occurrence relative to at least one of an impact history for the athlete and a normalized average of impact occurrences for a set of said athletes, wherein said comparison is performed by said computer processor relative to a statistically significant threshold and is performed independently from said concussion risk test and said concussion risk assessment performed by said mobile application, wherein said computer processor triggers an alert notice being sent to authorized custodians when said statistical analysis has determined said statistically significant threshold has been exceeded.

9. The system of claim 1, wherein said centralized server receives a concussion diagnosis and records said concussion diagnosis in said database for the athlete and correlates said concussion diagnosis to at least one of said concussion risk assessment and said impact occurrence, and wherein said centralized server receives a video of the impact to the athlete and correlates said video to at least one of said concussion risk assessment, said impact occurrence and said concussion diagnosis.

10. The system of claim 9, wherein said concussion diagnosis is at least one of a positive diagnosis and a negative diagnosis, wherein said processor performs a statistical analysis with a comparison of said impact occurrence relative to at least one of an impact history for the athlete and a normalized average of impact occurrences for a set of said athletes, wherein said processor analyzes said concussion diagnosis relative to a plurality of positive and negative concussion diagnoses from a plurality of medical professionals for said respective athletes documented in said database and wherein said corresponding concussion risk assessment and statistical analysis is respectively correlated to a plurality of concussion risk assessments and a plurality of impact occurrences to feedback into and incrementally adjust said normalized average and statistical analysis.

11. The system of claim 9, wherein said centralized server calculates an individual athlete alert threshold based on said plurality of impact occurrences relating to said plurality of respective athletes and at least one of a positive concussion diagnosis and a negative concussion diagnosis for the athlete wearing said impact sensor, wherein said centralized server interactively communicates said individual athlete alert threshold to at least one of said mobile application and said impact sensor, wherein said impact sensor uses said individual athlete alert threshold to compare with said impact data, and wherein said impact sensor triggers a warning when said impact data exceeds said individual athlete alert threshold.

12. The system of claim 1, wherein said centralized server calculates a general alert threshold based on said plurality of impact occurrences relating to a plurality of concussion risk assessments and a plurality of corresponding concussion diagnoses, wherein said centralized server interactively communicates said general alert threshold to at least one of said mobile application and said impact sensor, wherein said impact sensor uses said general alert threshold to compare with said impact data, and wherein said impact sensor triggers a warning when said impact data exceeds said general alert threshold.

13. A system for monitoring and evaluating one or more impacts to the head of an athlete during sporting events, comprising:
an impact sensor operatively worn on the head of the athlete and comprising an accelerometer, a battery, a micro-processor, a data-storage memory and a wireless communications module, wherein said battery powers said accelerometer, said micro-processor and said wireless communications module, wherein said accelerometer measures impacts and produces impact data, wherein said micro-processor determines and records in said data-storage memory a set of said impact data corresponding to an impact occurrence for a high-g impact exceeding a threshold impact level, wherein said micro-processor determines and immediately transmits said impact occurrence through said wireless communications module when said high-g impact exceeds an alert threshold, and wherein said impact occurrence is comprised of said impact data correlated with a time stamp;
a mobile application comprising a wireless communication protocol paired with said impact sensor through an operative communication with said wireless communications module and further comprising a prompt screen displaying a concussion risk test, wherein said concussion risk test is comprised of a plurality of response entries to a plurality of query prompts, wherein said mobile application receives said impact occurrence through said wireless communications link according to said wireless communication protocol, wherein said concussion risk test is performed independently from a determination by said impact sensor whether any of said measured impacts qualify as said high-g impact exceeding said threshold impact level, wherein said concussion risk test is automatically recommended by said mobile application when said measured impact exceeds said alert threshold, and wherein said mobile application performs a concussion risk assessment for the athlete in association with said concussion risk test; and
a centralized server comprising a computer processor, a memory and a communications module, wherein said computer processor controls a database application and an interactive user interface, wherein said memory stores a plurality of impact occurrences in association with a plurality of respective athletes according to said database application, wherein said computer processor correlates said respective athletes to a plurality of user accounts, wherein said centralized database receives said set of impact data and said concussion risk assessment and correlates said impact occurrence and said concussion risk assessment with one of said user accounts corresponding with the athlete wearing said impact sensor.

14. The system of claim 13, wherein said mobile application is further comprised of a sideline application in wireless communication with a plurality of impact sensors worn on and corresponding to a plurality of team athletes, and wherein said mobile application periodically receives a plurality of impact occurrences from said plurality of impact sensors and correlates said impact occurrences with said team athletes.

15. The system of claim 13, wherein said mobile application is further comprised of a sideline application in wireless communication with a plurality of impact sensors worn on and corresponding to a plurality of team athletes, and wherein said mobile application produces an alert identifying the athlete from said plurality of team athletes based on said impact sensor triggering said wireless transmission.

16. The system of claim 13, wherein said concussion risk test further comprises an athlete identification field through which said mobile application receives athlete identification information, wherein said concussion risk assessment is further comprised of a risk evaluation of said response entries relative to a pass/fail criteria to produce at least one of a cleared test result, a warning test result and a failed test result, wherein said mobile application communicates said athlete identification information and said concussion risk assessment to said centralized server, wherein said computer processor correlates said concussion risk assessment to said impact occurrence for said identified athlete, wherein a concussion risk notice is sent to authorized custodians corresponding to said user accounts associated with said identified athlete through at least one of said mobile application and said centralized database when at least one of a warning test result and failed test result has been produced, and wherein said mobile application is further comprised of an interactive user application in operative communication with at least one of said user accounts on said centralized server through said interactive user interface.

17. The system of claim 13, wherein said computer processor performs a statistical analysis with a comparison of said impact occurrence relative to at least one of an impact history for the athlete wearing said impact sensor and a normalized average of impact occurrences for a set of said athletes, wherein said comparison is performed by said computer processor relative to a statistically significant threshold and is performed independently from said concussion risk test and said concussion risk assessment performed by said mobile application, wherein said computer processor triggers an alert notice being sent to authorized custodians when said statistical analysis has determined said statistically significant threshold has been exceeded, wherein said computer processor determines a new alert threshold for at least one of the athlete and said set of athletes, wherein said centralized server communicates said new alert threshold to said impact sensor and wherein said impact sensor updates said alert threshold with said new alert threshold.

18. A method for monitoring and evaluating impacts to the head of an athlete during sporting events, comprising the steps of:
(a) defining a threshold impact level in an impact sensor for recording impact data;
(b) storing a plurality of impact occurrences in association with a plurality of respective athlete accounts in a database;
(c) associating an athlete account in said database with the athlete;
(d) receiving impact data in said database, wherein said impact data corresponds with an impact occurrence for the athlete;
(e) performing a concussion risk test on the athlete, wherein said concussion risk test comprises a plurality of response entries to a plurality of query prompts on a mobile application;
(f) determining a concussion risk assessment for the athlete in association with said concussion risk test;
(g) uploading said concussion risk assessment to said athlete account in said database;
(h) correlating said concussion risk assessment to said impact occurrence in said database for said athlete account; and
(i) repeating steps d, e, f, g and h to create an impact history for the athlete associated with said athlete account.

19. The method of claim 18, further comprising the steps of:
determining an alert threshold based on sets of impact occurrences correlated with corresponding sets of concussion risk assessments and concussion diagnoses;
correlating a plurality of videos with said sets of impact occurrences, wherein said videos show the impacts to the heads of athletes;
instructing said impact sensor to trigger a warning when said impact occurrence exceeds said alert threshold; and
communicating alerts to authorized custodians when said alert threshold is exceeded by said impact data.

20. The method of claim 18, further comprising the steps of:
receiving a concussion diagnosis in said database;
correlating said concussion diagnosis with at least one of said impact occurrence and said concussion risk assessment;
performing a statistical analysis with a comparison of said impact occurrence relative to at least one of said impact history for the athlete and a normalized average of impact occurrences for a set of said athletes;
evaluating a plurality of concussion risk assessments, a plurality of impact occurrences and a plurality of concussion diagnoses according to said normalized average and said statistical analysis;
adjusting said normalized average and statistical analysis;
calculating a general alert threshold based on said plurality of impact occurrences relating to said concussion risk assessments and corresponding concussion diagnoses; and
instructing said impact sensor to update said alert threshold with said general alert threshold.
